(19) United States
(12) Patent Application Publication
(10) Pub. No.: US 2022/0345436 A1
(43) Pub. Date: Oct. 27, 2022

(54) CROSS-PLATFORM MESSAGE MANAGEMENT SYSTEM

(71) Applicant: Saint John Group LLC, Cincinnati, OH (US)

(72) Inventors: Holly Maloney, Cincinnati, OH (US); Colton Laker, Sunman, IN (US); Chelsea Hitzler, Cincinnati, OH (US); Matthew Jent, Cincinnati, OH (US); Shahil Shah, Mumbai (IN); Troy Davis, Norwood, OH (US)

(21) Appl. No.: 17/635,975

(22) PCT Filed: Aug. 17, 2020
(86) PCT No.: PCT/US2020/046642

§ 371 Date: Feb. 16, 2022

Related U.S. Application Data
(60) Provisional application No. 63/037,722, filed on Jun. 11, 2020.
(60) Provisional application No. 62/887,874, filed on Aug. 16, 2019.

(51) Int. Cl. H04L 51/56; H04L 51/216; H04L 67/306; H04L 51/52

(52) U.S. Cl. CPC H04L 51/56; H04L 51/216; H04L 67/306; H04L 51/52

(57) ABSTRACT

Systems, methods, and computer program products for organizing messages received through different channels and from multiple sources. In response to receiving a message at a user system from a first communication channel, the user is prompted to identify a bucket to which the message should be added. In response to receiving input identifying the bucket, the message is stored and indexed to the identified bucket. Messages are thereby organized so that messages pertaining to the same matter are indexed to the same bucket. In cases where a query is received from a message application requesting instructions for processing the message, the user system transmits a reply to the message application instructing the message application to forward the message to a network address where the message is received from a second communication channel different than the first communication channel.

### CROSS-REFERENCE TO RELATED APPLICATIONS

This application claims the benefit of U.S. Application No. 62/887,874, filed on Aug. 16, 2019, and entitled “Cross-Platform Message Management System”, and U.S. Application No. 63/037,722, filed on Jun. 11, 2020, and entitled “Cross-Platform Message Management System Including Message Forwarding Through Alternative Channel”, the disclosures of which are each incorporated by reference herein in their entireties.

### BACKGROUND

This invention generally relates to data management and, in particular, to methods, systems, and computer program products for managing messages.

Modern business is often conducted using messaging services over multiple platforms. When a sales associate receives messages regarding the same transaction through multiple channels or persons, it can be difficult to determine the order in which messages were received. It can also be difficult to determine which subjects have already been addressed in previously reviewed messages. Messages can also lose their context when viewed on different platforms at different times due to the associate forgetting details of a previously read message. This problem can be exacerbated on at least some platforms by an inability of third-party applications to access message data on certain types of messages. Thus, it can be difficult to properly interpret all the messages related to a transaction. This often leads to difficulties determining the current status of the transaction and how to respond to a particular message.

Thus, there is a need for improved systems, methods, and computer program products which enable users to organize messages received through different channels and from multiple people.

### SUMMARY

In an embodiment of the invention, a system is provided. The system includes one or more processors, and a memory coupled to the one or more processors. The memory includes program code that, when executed by the one or more processors, causes the system to receive a first message from a first communication channel of a plurality of communication channels. In response to receiving the first message, the program code causes the system to prompt a user to identify a bucket to which the first message should be added. In response to receiving input identifying the bucket, the program code causes the system to store the first message in a database, and index the first message to the identified bucket in the database.

In an aspect of the invention, the first message may be associated with a thread including a plurality of messages.

In another aspect of the invention, the program code may further cause the system to define the thread based on participants in the thread, and the participants may include a sender of the first message and a recipient of the first message.

In another aspect of the invention, the program code may further cause the system to index the first message to the thread in the database.

In another aspect of the invention, the plurality of communication channels may include a social media messaging channel, a text messaging channel, and an email channel.

In another aspect of the invention, the program code may comprise a client application running on a user system and a server application running on a server system, the first communication channel may have a first format, and the program code may further cause the system to receive, by the server application, a second message from a second communication channel having a second format. The program code may cause the system to reformat, by the server application, the second message into the first format, and transmit the reformatted second message from the server application to the client application.

In another aspect of the invention, the first communication channel may be a text messaging communication channel, and the second communication channel may be a social media system communication channel.

In another aspect of the invention, the program code may further cause the system to receive, by a filter application from a message application, a query requesting instructions for processing the first message received from the first communication channel. In response to receiving the query, the program code may further cause the system to transmit, by the filter application, a reply to the message application instructing the message application to forward the first message to a first network address, and receive, by a management application, the first message from a second communication channel different than the first communication channel.

In another aspect of the invention, the program code may further cause the system to receive the first message at a server associated with the first network address, determine, by the server, a second network address associated with the management application, and transmit the first message from the server to the second network address.

In another aspect of the invention, the server may determine the second network address based on data contained in the first message that identifies a mobile device.

In another aspect of the invention, the data that identifies the mobile device may include a phone number.

In another aspect of the invention, the first network address may be a fixed network address.

In another aspect of the invention, the filter application may not monitor second communication channel.

In another embodiment of the invention, a method is provided. The method includes receiving the first message from the first communication channel of the plurality of communication channels. In response to receiving the first message, the method prompts a user to identify the bucket to which the first message should be added. In response to receiving input identifying the bucket, the method stores the first message in the database, and indexes the first message to the identified bucket in the database.

In another aspect of the invention, the method may define the thread based on participants in the thread, and the participants may include the sender of the first message and the recipient of the first message.

In another aspect of the invention, the method may further include indexing the first message to the thread in the database.

In another aspect of the invention, the first communication channel may have the first format, and the method may further include receiving, by the server application, the second message from the second communication channel having the second format, reformatting, by the server application, the second message into the first format, and transmitting the reformatted second message from the server application to a client application.

In another aspect of the invention, the method may further include receiving, by the filter application from the message application, the query requesting instructions for processing the first message received from the first communication channel. In response to receiving the query, the method may further include transmitting, by the filter application, the reply to the message application instructing the message application to forward the first message to the first network address, and receiving, by the management application, the first message from the second communication channel different than the first communication channel.

In another aspect of the invention, the method may further include receiving the first message at the server associated with the first network address, determining, by the server, the second network address associated with the management application, and transmitting the first message from the server to the second network address.

In another embodiment of the invention, a computer program product is provided. The computer program product includes a non-transitory computer-readable storage medium, and program code stored on the non-transitory computer-readable storage medium. The program code is configured so that when the program code is executed by one or more processors, the program code causes the one or more processors to receive the first message from the first communication channel of the plurality of communication channels. In response to receiving the first message, the program code further causes the one or more processors to prompt the user to identify the bucket to which the message should be added. In response to receiving input identifying the bucket, the program code further causes the one or more processors to store the first message in the database, and index the first message to the identified bucket in the database.

In another aspect of the invention, the program code may further cause the one or more processors to define the thread based on participants in the thread, and the participants may include the sender of the first message and the recipient of the first message.

In another aspect of the invention, the program code may further cause the one or more processors to index the first message to the thread in the database.

In another aspect of the invention, the program code may comprise the client application running on the user system and the server application running on the server system, the first communication channel may have the first format, and the program code may further cause the one or more processors to receive, by the server application, the second message from the second communication channel having the second format, reformat, by the server application, the second message into the first format, and transmit the reformatted second message from the server application to the client application.

In another aspect of the invention, the program code may further cause the one or more processors to receive, by the filter application from the message application, the query requesting instructions for processing the first message received from the first communication channel. In response to receiving the query, the program code may cause the one or more processors to transmit, by the filter application, the reply to the message application instructing the message application to forward the first message to the first network address, and receive, by the management application, the first message from the second communication channel different than the first communication channel.

In another aspect of the invention, the program code may further cause the one or more processors to receive the message at the server associated with the first network address, determine, by the server, the second network address associated with the management application, and transmit the message from the server to the second network address.

In another embodiment of the invention, a system is presented. The system includes one or more processors, and a memory coupled to the one or more processors. The memory includes program code that, when executed by the one or more processors, causes the system to receive, by the filter application from the message application, the query requesting instructions for processing the first message received via the first communication channel. In response to receiving the query, the program code causes the system to transmit, by the filter application, the reply to the message application instructing the message application to forward the first message to the first network address, and receive, by the management application, the first message via the second communication channel different than the first communication channel.

In another aspect of the invention, one or more of the filter application, the message application, and the management application may be resident on the system.

In another embodiment of the invention, a method is provided. The method includes receiving, by the filter application from the message application, the query requesting instructions for processing the message received via the first communication channel. In response to receiving the query, the method further includes transmitting, by the filter application, the reply to the message application instructing the message application to forward the message to the first network address, and receiving, by the management application, the message via the second communication channel different than the first communication channel.

In an aspect of the invention, the method may further include receiving the message at the server associated with the first network address, determining, by the server, the second network address associated with the management application, and transmitting the message from the server to the second network address.

In another embodiment of the invention, a computer program product is provided. The computer program product includes a non-transitory computer-readable storage medium, and program code stored on the non-transitory computer-readable storage medium. When executed by the one or more processors, the program code causes the one or more processors to receive, by the filter application from the message application, the query requesting instructions for processing the message received via the first communication channel. In response to receiving the query, the program code causes the one or more processors to transmit, by the filter application, the reply to the message application instructing the message application to forward the message to the first network address, and receive, by the management application, the message via the second communication channel different than the first communication channel.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

FIG. 1 is a diagrammatic view of an operating environment that includes one or more social media systems, messaging systems, contact systems, and a message management system.

FIG. 2 is a flowchart of a process that may be executed by the message management system of FIG. 1.

FIG. 3 is a diagrammatic view of a messaging sequence for a message received by a user system of the message management system of FIG. 1.

FIGS. 4-37 are graphical views of exemplary screens that may be displayed by a user interface of the user system.

FIG. 38 is a diagrammatic view of a computer that may be used to implement one or more of the components or processes shown in FIGS. 1-37.

### DETAILED DESCRIPTION

Embodiments of the invention are directed to a message management system that receives messages from and transmits messages to a plurality of different messaging platforms, as well as methods and computer program products for operating the system. The message management system enables users to quickly sort these messages based on one or more factors (e.g., participants in the message or a transaction associated with the message) to improve communication between multiple parties using multiple communication channels to discuss a subject. The recipient of a message may respond using any channel through which the recipient has communicated with the sender, e.g., the channel used to send the message being responded to, the most recent channel used by the sender, or any other communication channel associated with the sender. The message management system may thereby improve the ability of users to perform customer relationship management activities with each person who messages them across multiple messaging platforms concurrently.

In response to receiving a message, the message management system may prompt the user to identify one or more persons (natural or otherwise) to which the message should be associated. The system may use this identification to group messages between particular participants into a thread. Users may also identify one or more buckets into which the message or thread should be added. In response to receiving the input identifying the thread or bucket, the message management system may store the message in the database and index the message to the identified thread or bucket in the database.

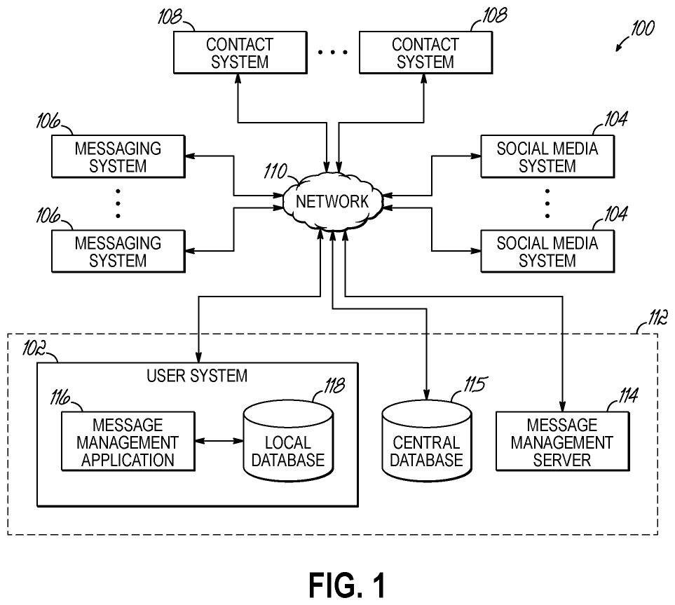

FIG. 1 depicts an operating environment 100 for embodiments of the invention that includes a message management system 112, one or more social media systems 104, one or more messaging systems 106, and one or more contact systems 108 in communication with a network 110. The message management system 112 may include a user system 102, a message management server 114, and a central database 115. The network 110 may include one or more data networks such as a local access network (LAN), a wide access network (WAN), a wireless network (e.g., Wi-Fi or cellular network), the Internet, or any other suitable network for transmitting data between one or more of the one or more social media systems 104, messaging systems 106, contact systems 108, user system 102, message management server 114, and central database 115.

Each of the one or more social media systems 104 may include one or more servers or databases that provide a virtual community through which users can create and share information. A member of a social media group may log into an account maintained by the respective social media system 104 to access information uploaded to the social media system 104 by other members, and to upload their own information to share with other members of the community. Members may access their account using a client application such as a web-browser, or using a custom application (e.g., a mobile app) provided by the operator of the social media system 104. The social media systems 104 may also provide messaging services through which members can exchange information with other members, either individually or as a group. These messages may be exchanged using a web-based interface, or any other suitable interface.

The messaging systems 106 may include one or more email systems, instant messaging systems, short-messaging-service (SMS) systems, multimedia messaging service (MMS) systems, or any other messaging system that can be used to exchange messages between one or more contacts and the user. To this end, each messaging system 106 may include a server application (e.g., an email server or message server) that communicates with a corresponding client application (an email client or message client) in a remote computing device.

User system 102 may be mobile device (e.g., a smart phone) or other suitable computing device, such as a tablet, laptop, or desktop computer. The user system 102 may include a message management application 116 configured to receive messages from and transmit messages to one or more of the social media systems 104, messaging systems 106, contact systems 108, and message management server 114. The user system 102 may also include a local database 118 that the message management application 116 can use to store and organize messages received from and transmitted to other systems. The central database 115 and local database 118 may be periodically synchronized. This synchronization may include updating the contents of the local database 118 based on the contents of the central database 115 (e.g., adding new messages received by the message management server 114, restoring accidentally deleted messages from backups stored in the central database 115, populating the local database 118 in a new handset with records stored in the central database 115, etc.) as well as updating the contents of the central database 115 based on the content of the local database 118 (e.g., adding new messages received by the user system 102 and stored in the local database 118, updating the central database 115 based on changes to the status or organization of messages previously stored in the local database 118, etc.).

The message management server 114 may be configured to communicate with the one or more social media systems 104 using an application programming interface (API), e.g., a webhook or another suitable interface. The message management server 114 may receive messages from one or more of the social media systems 104 and forward the messages to the user system 102. The message management server 114 may also receive messages from the user system 102 (e.g., as a response to a social media message) and forward the messages to one or more of the social media systems 104. The message management server 114 may thereby provide a message gateway that enables the exchange of messages between the user system 102 and social media systems 104. To this end, the message management server 114 may reformat received messages so that they are compatible with or properly displayed by the destination system. The message management server 114 may also arbitrate communication between the central database 115 and local database 118. The central database 115 may be a cloud-based database that maintains master records for all communications by each system user. Access to the master records may be regulated by the message management server 114 so that only records each user is authorized to access are shared with the message management application 116 or local database 118.

The message management application 116 may interface with one or more messaging, social media, or browsing applications residing on the user system 102 through an API or other suitable interface, and may operate as a client application to the messaging management server 114. The message management application 116 may store received and transmitted messages in the local database 118, and index the messages based on message metadata, user input, or both metadata and user input. Message metadata may include data identifying the channel from which the message originated (e.g., the social media messenger, email, SMS, etc.), the person sending the message, the recipients of the message, or the content of the message, for example.

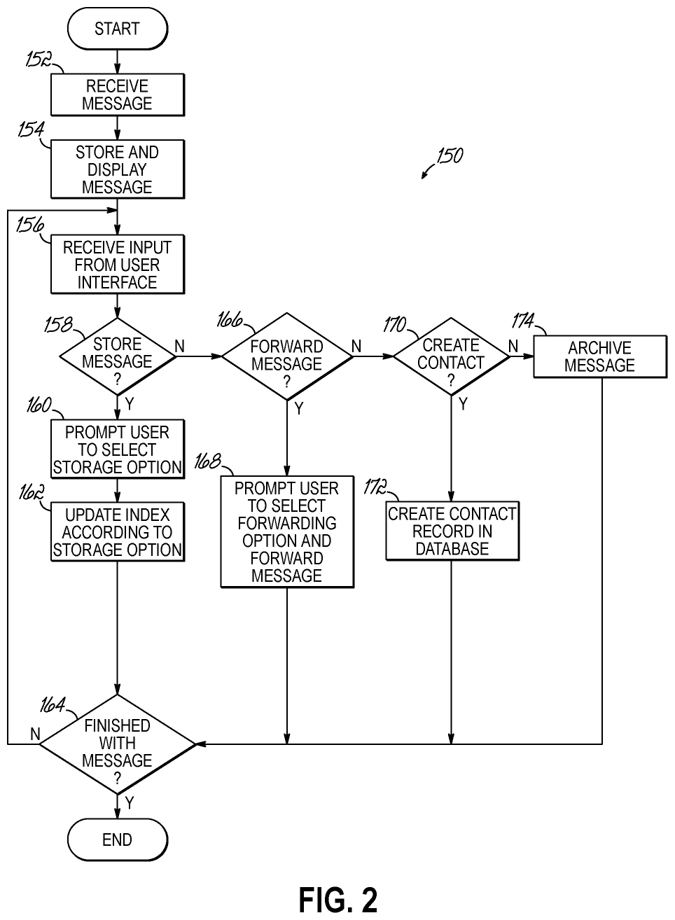

FIG. 2 depicts a flowchart illustrating a process 150 that may be executed by the message management system 112 to facilitate message review and organization by the user. In block 152, the process 150 receives a message, e.g., at the user system 102 or message management server 114. In response to receiving the message, the process 150 may proceed to block 154. In block 154, the process 150 may cause the message to be displayed by the user system 102, e.g., as a popup window containing the text of the message, and store the message in the local database 118. Storing the message in the local database 118 may include indexing the message based on metadata of the message. Exemplary metadata used to index the message may include one or more of an identity associated with the sender of the message (e.g., an email address, phone number, user name, social media account number, Internet Protocol address (IP) address, etc.), the identity or identities of the recipients of the message, the type of message (e.g., email message, SMS message, social media message), the content (e.g., keyword or subject) of the message, a time stamp, or any other suitable characteristic of the message. In an embodiment of the invention, the message may be indexed based on the identities of the sender and recipients of the message so that messages are grouped into threads based on the participants in the message thread. A single contact may be associated with multiple identities so that messages from the same contact that arrive through different channels (e.g., one or more email addresses, social media platforms, or phone numbers, etc.) can be indexed to the same thread when appropriate.

In block 156, the process 150 may receive input from the user interface of user system 102 indicating how the user would like the message processed. Input may be provided, for example, by the user swiping across the popup window displaying the message on a touch screen of the user system 102. Swipes may include swiping right, swiping left, swiping up, swiping down, or some other suitable swiping action, with each swipe resulting in a different action by the process 150. For example, swiping left may cause the message to be archived, swiping up may cause the message to be forwarded, and swiping right may cause the user interface to display a menu of options for processing the message (e.g., display buckets in which the message may be stored, mark the message important, archive the message, attach notes to the message, set a reminder, send message to assistant, add event to calendar, or create a new bucket), and swiping down may cause the process 150 to create a new contact. It should be understood that other types of gestures may be used to control the message management application 116 other than swiping. By way of example, these gestures may include, but are not limited to, tap, scroll, pan, drag, pinch, shake, long press, hard press, or any other suitable gestures. Thus, embodiments of the invention are not limited to any particular type of gestures.

Once the input has been received from the user, the process 150 may proceed to block 158. In response to the user input indicating that the user would like to store the message (“YES” branch of decision block 158), the process 150 may proceed to block 160 and prompt the user to select a storage option, e.g., a bucket in which to put the message. In response to the user selecting a storage option, the process 150 may proceed to block 162 and update the local database 118 according to the storage option selected. For example, if the user indicates they would like to store the message in a “leads” bucket, the process 150 may update the local database 118 to indicate that the message is associated with the leads bucket and proceed to block 164.

If the user input does not indicate that the user would like to store the message (“NO” branch of decision block 158), the process 150 may proceed to block 166 and determine if the user input indicates the user would like to forward the message. If the user input indicates that the user would like to forward the message (“YES” branch of decision block 166), the process 150 may proceed to block 168. In block 168, the process 150 may prompt the user to select a forwarding option (e.g., select a contact and messaging platform). In response to the user selecting a forwarding option, the process 150 may forward the message and proceed to block 164.

If the user input does not indicate the user would like to forward the message (“NO” branch of decision block 166), the process 150 may proceed to block 170 and determine if the user input indicates the user would like to create a contact. If the user input indicates that the user would like to create a contact (“YES” branch of decision block 170), the process 150 may proceed to block 172. In block 172, the process 150 may create a contact record in the local database 118 and proceed to block 164. The contact record may include one or more fields each including data defining a unit of information, e.g., a name, an email address, a phone number, or a social media account identity. The units of information used to populate the fields of the record may be obtained from the metadata of the message or entered by the user. The contact records may be indexed based on the content of their fields so that the database records can be searched based on this information.

If the user input does not indicate the user is creating a contact (“NO” branch of decision block 170), the process 150 may proceed to block 174, archive the message, and proceed to block 164. Archiving the message may include storing the message the local database 118 with a flag indicating that it should not be displayed in any associated threads, moving the message to a deleted message bucket, or any other appropriate action. This may allow the user to delete or otherwise hide messages of low value, thereby reducing clutter in message threads.

In block 164, the process 150 may determine if the user is finished reviewing, sorting, or routing the message. If the user is not finished with the message (“NO” branch of decision block 164), the process 150 may proceed to block 156 and await additional input from the user interface. If the user is finished with the message (“YES” branch of decision block 164), the process 150 may terminate.

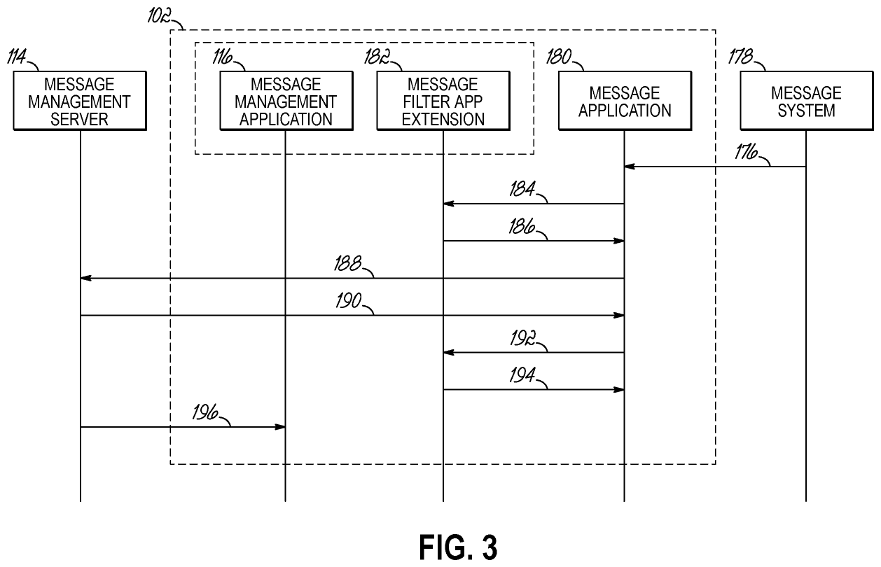

FIG. 3 depicts a messaging sequence in which a message is received by the user system 102. In a multi-platform environment, a message sent by a contact known to the user may be received from new or previously unused source, e.g., a platform or account that the contact has not used to message the user before. In scenarios where the user system 102 has not previously seen a message from a particular source, the user system 102 may treat the message as spam, or otherwise fail to forward the message to the message management application 116. Applications running on the user system 102 may also be blocked from accessing data contained in the message for security purposes, e.g., to prevent malware applications from accessing personal information, such as passwords, personal identification numbers, or two-factor authentication codes.

In the depicted scenario, the user system 102 receives a message 176 from a message system 178. The message system 178 may include, for example, a message server for a social media system 104, a messaging system 106, or contact system 108. The user system 102 may include a message application 180 configured to process certain types of messages. For example, smart phones typically include one or more built-in message applications that perform initial processing of all received MMS or SMS messages.

The message application 180 may include a filtering feature that determines how the message 176 should be processed. For example, should the message trigger a notification signal, be forwarded to another application resident on the user system 102, or stored in a junk message folder. The filtering feature may also limit how the content of the message can be shared with other applications resident on the user system 102, such as the message management application 116. The filtering feature may be implemented using a message filter application extension 182 that is contained in or otherwise associated with the message management application 116. The ability to associate an application with a particular message filter application extension 182 may facilitate managing message filtering separately for different applications or users of the user system.

In response to the message application 180 receiving the message 176, the message application 180 may transmit a query 184 to the message filter application extension 182. The query 184 may include data from the message which the message filter application extension 182 uses to determine how the message 176 should be processed. For example, if the message is from an unknown source, the message processing rules may indicate that the message should be treated differently than a message from a known source. The message filter application extension 182 may be configured to make this determination using an internal database and message processing rules, or by deferring the determination to an external system. That is, the message filter application extension 182 may execute the message evaluation process entirely on user system 102 using rules and databases stored locally, or the message may be forwarded to an external system for evaluation. In order to protect sensitive information which may be contained in the message 176, the message filter application extension 182 may be configured to prohibit passing at least part of the contents of message 176 to the message management application 116. This prohibition may be maintained regardless of the outcome of the evaluation.

In response to receiving the query 184, the message filter application extension 182 may transmit a reply 186 to the message application 180 indicating the message 176 should be forwarded to the message management server 114 for evaluation. To maintain security, the message filter application extension 182 may be required to specify a fixed network address, such as a uniform address locator (URL), to which the message 176 can be forwarded. The message application 180 may prohibit passing any variables (e.g., to prevent passing data that identifies the user), and may require the use of a secure connection between the user system 102 and message management server 114 that provides end-to-end protection. The user system 102 may also be configured to process all communication between the message filter application extension 182 and external systems. This restriction may be enforced, for example, by prohibiting the message filter application extension 182 from accessing the network 110, and thus the message management server 114, directly. In addition, the message filter application extension 182 may be prohibited from writing data to containers shared with the associated message management application 116.

In response to receiving a reply 186 including instructions to forward the message 176 to the network address, the message application 180 may transmit a query 188 including the content of the message 176 to the message management server 114. The message management server 114 may process the query 188 and transmit a reply 190 to the message application 180. The reply 190 may include instructions on how to process the message 176. In response to receiving the reply 190, the message application 180 may transmit a reply 192 to the message filter application extension 182 including information about the message. The application extension may then transmit a decision message 194 to the message application 180.

For security reasons, the user system 102 may be configured to process all communication with external systems. Thus, the user system 102 may prohibit the message filter application extension 182 from accessing the network 110, and thus the message management server 114, directly. The user system 102 may also prohibit the message filter application extension 182 from writing data to containers shared by the message management application 116 to which it is associated. The inability to share message content with the message management application 116 may prevent the message 176 from being integrated into an existing message thread.

In order to address this problem, the message management server 114 may transmit a message 196 directly to the message management application 116 using another communication channel. For example, the message management server 114 may establish a communication channel (e.g., an application layer connection) with the message management application 116 through the network 110 using a suitable network communication protocol. The message management application 116 may thereby transmit the content of the message 176 to the message management application 116 on the user system 102. The content of the message 176 may then be used to construct a threaded message.

The user system 102 may be configured to prevent applications from seeing message data in order to prevent spyware applications from accessing personal information contained in the content of the message. To this end, the message filter application extension 182 may be a software component that is configured to receive the contents of incoming messages, but that cannot share the contents with its associated application. This feature may protect personal information that is contained in messages. The message filter application extension 182 may also be configured so that it can only transmit a reply back to the message application 180. This feature may prevent the message filter application extension 182 from forwarding message contents directly to an external system.

By instructing the message application to forward the message to the message management server 114, embodiments of the invention solve the above problem. The message management server provides an alternative channel through which the message contents and the sender's number can be provided to the message management application 116.

In an embodiment of the invention, the user system 102 may send information about an incoming text message to a third-party server (not shown), such as a provider of the user system 102 or the operating system thereof. The third-party server may, in turn, only forward a portion of the information to the message management server 114. In cases where the message management server 114 does not have access to all the information contained in the original message 176, the message management server 114 may determine whether to forward the message 196 to the user device 102 based on whether the message 176 appears to be spam. In another embodiment of the invention, the third-party server may only forward selected information, e.g., only an identity of the sender and the content of the message 176. That is, the forwarded information may not include an identity of the intended recipient of the message 176. In response to the forwarded information lacking an identifier that positively identifies the intended recipient, the message management server 114 may attempt to identify the intended recipient using other data.

To address the above issues, embodiments of the invention may identify one or more pieces of data (e.g., the IP address of user system 102) that are passed from the third-party server to the message management server 114. These pieces of data may be, for example, found in a header of an IP packet or other message. The message management server 114 may then be able to determine the identity of the intended recipient based on the one or more pieces of data. By way of example, the message management server 114 may maintain a record of identifiers (e.g., IP addresses) that have been associated with the user device 102 over time. The message management server 114 may then use these identifiers to determine the if the intended recipient of the message 176 is the user system 102. By way of example, the message management server 114 may use a set of weighted scoring factors to determine the likelihood that an identifier or other data passed from the third-party server refers to or has been associated with a particular user device 102 at a particular time.

Exemplary scoring factors may include matching an IP address in a packet header with an IP address recently in use by the user system 102, whether the sender has previously communicated with the user system 102 using the sender's phone number, the relative timing between filter determination requests received and user system 102 interactions from the same IP address, and whether the sender is a contact in a contact list of the user system 102. In cases where the intended recipient of message 176 can be positively identified (i.e., identified without ambiguity regarding the intended recipient), the message 176 may be stored for the intended recipient and a notification sent or updated on the user system 102, or the message 196 forwarded to the user system 102.

Advantageously, in cases were multiple users have used the application from the same IP address (such as multiple users using the same Wi-Fi connection, e.g., a Wi-Fi system in a public place), or if a matching identifier has not previously been associated with the user system 102, (e.g., because that user has not used the application recently), embodiments of the invention may avoid forwarding the message 196 to the wrong user system 102, or failing to deliver the message 176 without sending a notification to the sender.

In cases where the message management server 114 is unable to positively identify a message recipient, e.g., due to a limited amount of information being available, the message management server 114 may send an automated verification request to the sender. For example, if the message management server 114 cannot identify any likely recipients, it may send a message to the sender requesting information identifying the intended recipient, such as a phone number, email, name, or other identifying information. If the sender responds, message management server 114 may then attempt to find the user identified by the sender, and deliver the message. If the sender does not respond, the message management server 114 may decide not to transmit the message 196, and may send a notification to the sender of the original message 176 that the message 176 has not been delivered.

In cases where multiple user systems 102 have used the same IP address within a similar time-frame as the determination request, the message management server 114 may send a message to the sender asking them to reply with a number to indicate the intended recipient from a list of likely recipients, or provide contact information to help deliver the message to the intended recipient. The sender's response may then be used to route the message 196. Failures to route messages to intended users after a timeout period may cause the message management server 114 to send a notification to the sender notifying them of a failed delivery.

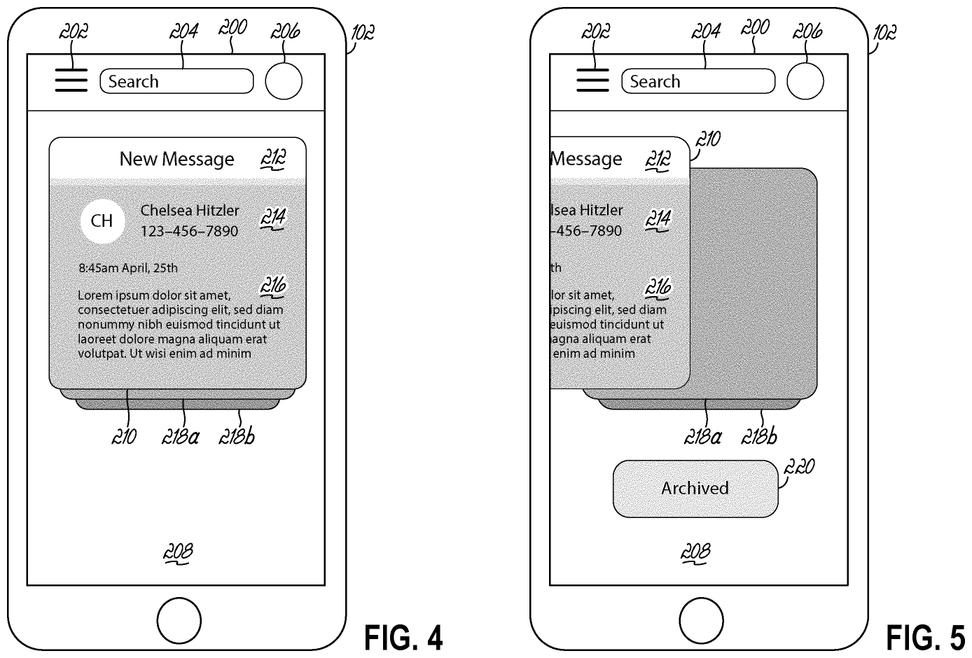

FIG. 4 depicts an exemplary user interface 200 that may be displayed by the user system 102. The user interface 200 may be a graphical user interface configured to display information to, and receive input from, the user. The user interface 200 may include a pull-down menu button 202, a data entry field 204 for entering search terms, an activation button 206 for activating a search function, and message review window 208. In response to receiving a new message, the message management system 112 may cause the user interface to display a pop-up window 210 in the message review window 208. The pop-up window 210 may include a header 212, a message identification field 214, and a message content field 216. The header 212 may display information regarding the message (e.g., new message, saved message, etc.), the message identification field 214 may display information relating to the source of the message (e.g., the social media system, contact identity, messaging system, phone number, IP address, etc. from which the message originated), and the message content field 216 may display the content of the message.

If a new message is received that is determined to be part of an existing message thread, the user interface 200 may also display other messages 218a, 218b in the thread (e.g., as a stack of messages) to provide a message context to the user. The user may drag the pop-up window 210 or select other messages 218a, 218b to selectively view messages in the stack of messages comprising the thread. Messages originating from social media systems 104 (e.g., Facebook), messaging systems 106 (e.g., email), and contact systems 108 (e.g., SMS messages) may be intercepted by the message management system 112. The message management system 112 may then generate a “Message Review” where the messages are displayed in the order the messages were received so that the user can organize the messages based on their business needs.

FIG. 5 depicts an exemplary scenario in which the user determines the message displayed in the pop-up window 210 should not be shown in the message thread. In this case, the user may provide input to the user interface 200 (e.g., by swiping left on the pop-up window 210) indicating the message should be archived. In response to the user providing this input, the message management application 116 may flag the message as being archived so that it is not displayed in the thread, and cause the user interface to display a pop-up object 220 indicating that the message has been archived. Once the user chooses to swipe left and sort that message, the pop-up window 210 may move off screen and out of the message review window 208.

FIG. 6 depicts an exemplary scenario in which the user determines the message displayed in the pop-up window 210 should be shown in the message thread or otherwise singled out as important. In this case, the user may provide input to the user interface 200 (e.g., by swiping right on the pop-up window 210) indicating the message should be kept. For example, a swipe right may open a menu that gives the user options based on their settings to choose actions for that message. In the depicted example, in response to the user providing this input, the message management system 112 may cause the user interface 200 to display a menu 222 including a plurality of buttons 224a-224g that provide the user with options for organizing the message. Exemplary buttons may include a button that causes the message management system 112 to add the sender to a contact list, to flag the message as important, or to add the message to a notes application. Exemplary buttons may also include one or more buttons that cause the message management system 112 to move the message to one or more corresponding buckets, e.g., a leads bucket, a new bucket, or a closing bucket. The buckets may be predefined by the message management system 112, or may be defined by the user.

In an embodiment of the invention, buttons may be displayed (e.g., while viewing a home or other general window) that allow the user to change settings, upgrade the message management application 116, open a calendar, add a thread, or view messages. Viewing options may include viewing the calendar, archived messages, contacts, important messages, notes, reminders, all messages, messages classified as leads, new messages, closing messages, progress messages, or any other type of message classification that have been defined by the user.

Message sorting options may include creating a new contact from information in the message, forwarding the message to an assistant, creating a calendar event based on a date or time defined in the message, assigning the message to a specific bucket based on a business or personal model for classifying contacts, marking the message as important or urgent to facilitate sorting important or urgent messages from other messages, attaching a note to the message or contact, and setting a reminder for acting on the message. The application may suggest contacts based on meta data from message, such as the name, phone number, email address, social media web address, IP address, etc. Along with creating a new contact from message sorting, users may also merge contacts based on suggestions from the application.

FIG. 7 depicts an exemplary scenario in which the user activates a button (e.g., button 224f) that moves the message to a bucket (e.g., the closing bucket). In response to the user providing this input, the message management system 112 may flag the message as being stored in the selected bucket, and cause the user interface to display a pop-up object 226 indicating that the message has been moved to the selected bucket. Once the user chooses to move the message to the bucket, the pop-up window 210 may move off screen and out of the message review window 208.

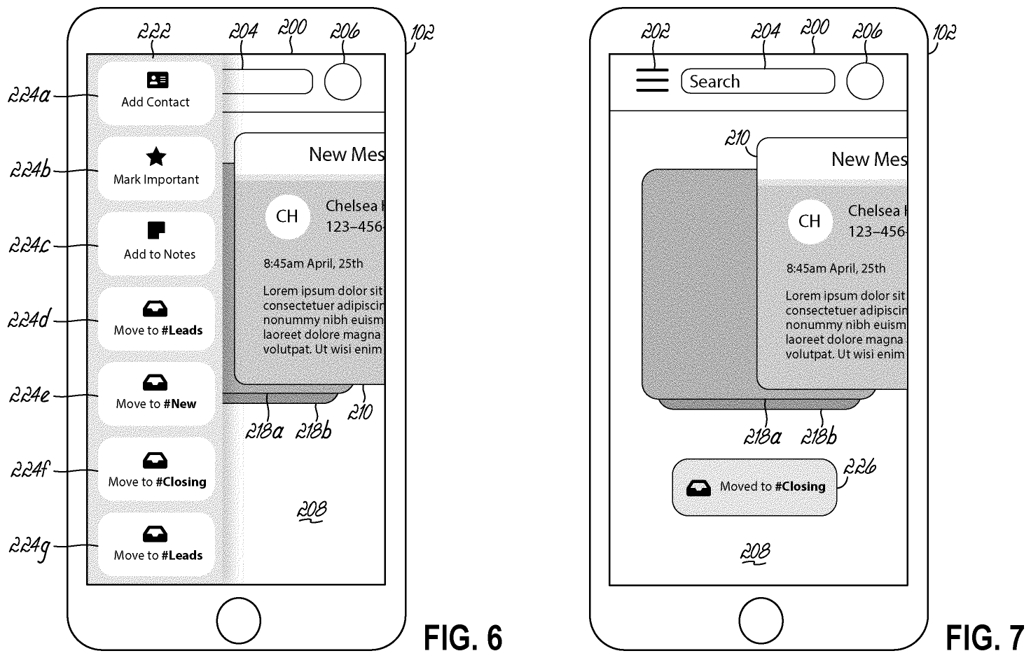

Referring now to FIG. 8, once all new incoming messages have been organized by the user, the message management application may transition to a general messages screen 228 that includes a plurality of windows 230 each associated with a message. The messages screen 228 may be configured so that the user can scroll through the plurality of windows 230 to search for messages, e.g., by dragging one of the windows 230 upward or downward. Each window 230 may include an icon 232 that identifies the contact (e.g., a picture or initials of the contact), a data field 234 that displays the subject of the message, a data field 236 that displays a portion of the message, and an icon 238 that indicates a characteristic of the message, e.g., that the message is urgent, important, etc.

In response to the user tapping on a window 230, the message management system 112 may cause the user interface 200 to display the message thread associated with the message. The message thread may thread related messages from all sources into a single thread so that no information is lost. That is, each message associated with the tread, whether it was received from a social media system 104, a messaging system 106, a contact system 108, or any other system, can be displayed in the same thread.

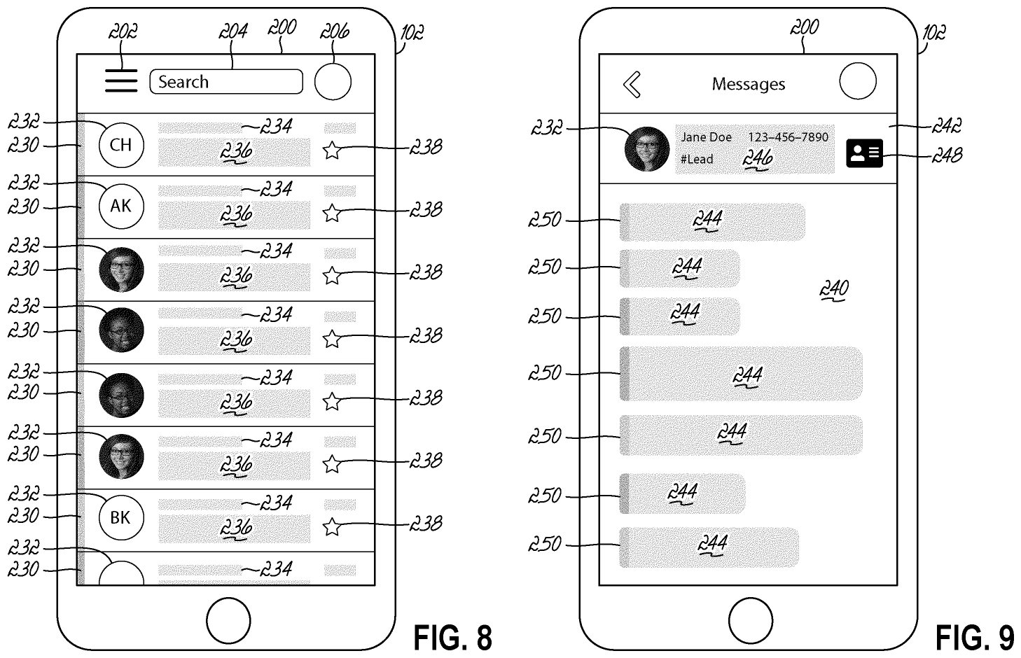

FIG. 9 depicts an exemplary message thread 240 that may be displayed by the user interface 200 in response to the user selecting a message window 230. The message thread 240 may include a header 242 and a plurality of message windows 244. The header 242 may include the identifying icon 232, a data field 246 that displays information about the contact or the message (e.g., name and contact information for contact and bucket where message is stored), and a button 248 that can be activated to display a contact list. The message windows 244 may be organized in the order in which the corresponding messages were received. Each window 244 may have an indicator 250 (e.g., a colored bar) that provides an indication of the platform from which the message was received, e.g., social media messenger, email, SMS, etc.

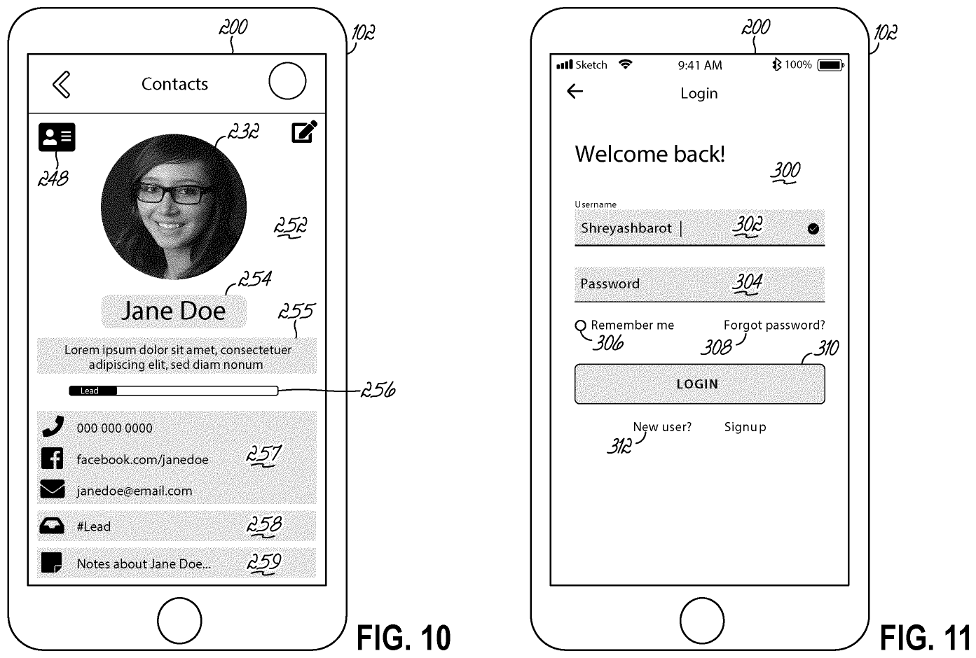

Referring now to FIG. 10, in response to the user activating the contact button 248, the message management system 112 may cause the user interface 200 to display a contact window 252. The contact window 252 may include the identifying icon 232, the contact button 248, and data fields 254-259 that display information about the contact, such as the name of the contact (e.g., Jane Doe), a description of the contact (e.g., the contact's employer and title), the type of contact, (e.g., a lead, buyer, seller, etc.), contact information for the contact (e.g., phone number, link to social media page, email address, etc.), the bucket in which the message is stored, and notes about the contact. The message management system 112 may intercept as much information about each contact as possible (e.g., social media profile, picture, email, social media name). The message management system 112 may also categorize the contact based on a specified sales funnel set to give the user as much information about the contact as possible.

FIGS. 11-14 depict screens that may be displayed by the user interface 200 to enable a user to set up an account and configure the message management system 112. FIG. 11 depicts a home screen 300 that may be displayed to a user who has recently activated the message management application 116, e.g., by tapping an icon displayed on the user interface 200 of user system 102. The home screen 300 may include a data field 302 for entering a username, a data field 304 for entering a password, a check box 306 for indicating whether the message management system 112 should remember the user's login information, a button 308 that launches a process for regaining access to the message management system 112 in the event the user has forgotten their password, a login button 310 the user can activate to log into the message management system 112 once they have entered their username and password, and a button 312 a user can use to launch a new user signup process.

Referring now to FIG. 12, in response to the user activating the new user button 312, the message management system 112 may cause the user interface 200 to display a screen 314 configured to receive data defining a new user account. To this end, the new user screen 314 may include data entry fields 316-322 for entering the user's first name, last name, email address, phone number, profession, password, and password confirmation. The new user screen 314 may also include a button 328 the user can activate to continue to the next screen after they have entered information into the data entry fields 316-322, and an indicator 330 that indicates which screen of a plurality screens comprising the new user account creation process the user is viewing.

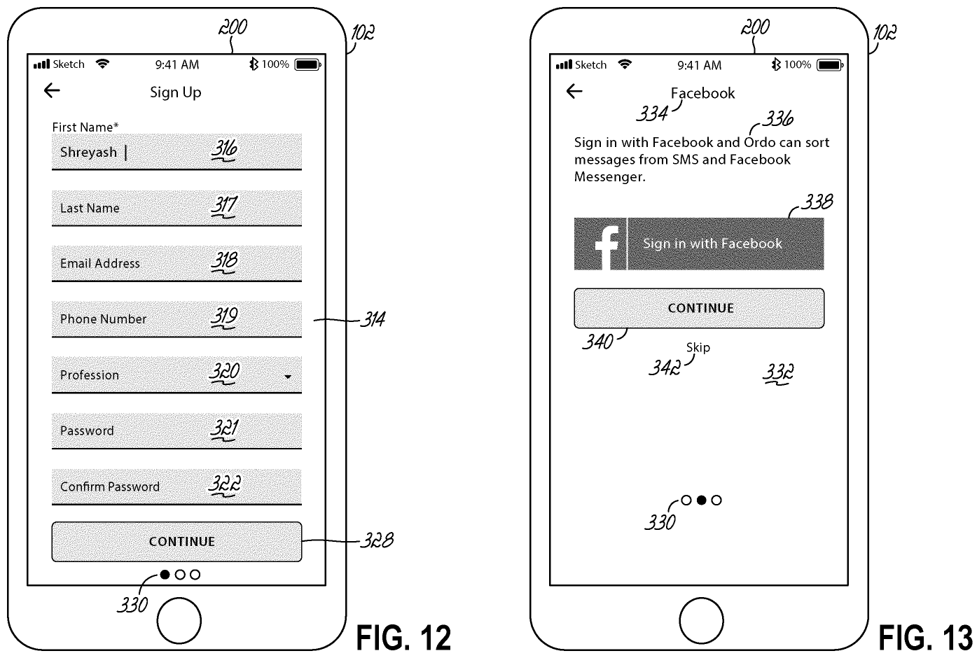

FIG. 13 depicts a screen 332 that may be displayed in response to the user activating button 328 of screen 314. Screen 332 may be configured to receive data that enables the message management system 112 to receive content from, and transmit content to, one or more social media systems 104 (e.g., Facebook, Google, Twitter, Zillow, etc.) on which the user has an account. Screen 332 may enable the user to sign into a social media account, thereby configuring the system to receive and transmit messages using a messaging application provided by the social media platform. To this end, the screen 332 may include a title field 334 that identifies the social media platform, a text field 336 that displays instructions to the user for configuring the system, a button 338 that launches a sign in process for the social media platform, a button 340 that takes the user to the next screen, and a button 342 that allows the user to skip this step of the user account setup process. Activating button 338 may bring up a data entry window that enables the user to enter their social media account information (e.g., user identity and password). In response to the user entering this information, the message management application 116 may transmit the information to the message management server 114. The message management server 114 may then use this information to access the user's social media account for the purpose of transmitting and receiving messages through the social media messaging application.

Referring now to FIG. 14, message management system 112 may cause the user interface 200 of user system 102 to display a screen 344 for setting up access for an assistant. The assistant access screen 344 may include data entry fields 346-348 for assistant information, e.g., the name, phone number, and email address for the assistant. Once the user has entered the assistant information, the assistant may be required to log in and enter a password to enable the account. When the user has finished entering the assistant data, they may activate a submit button 352 to proceed to the next screen. If the user does not wish to set up an assistant account, they may activate a check box 354 and proceed to the next screen without adding an assistant account.

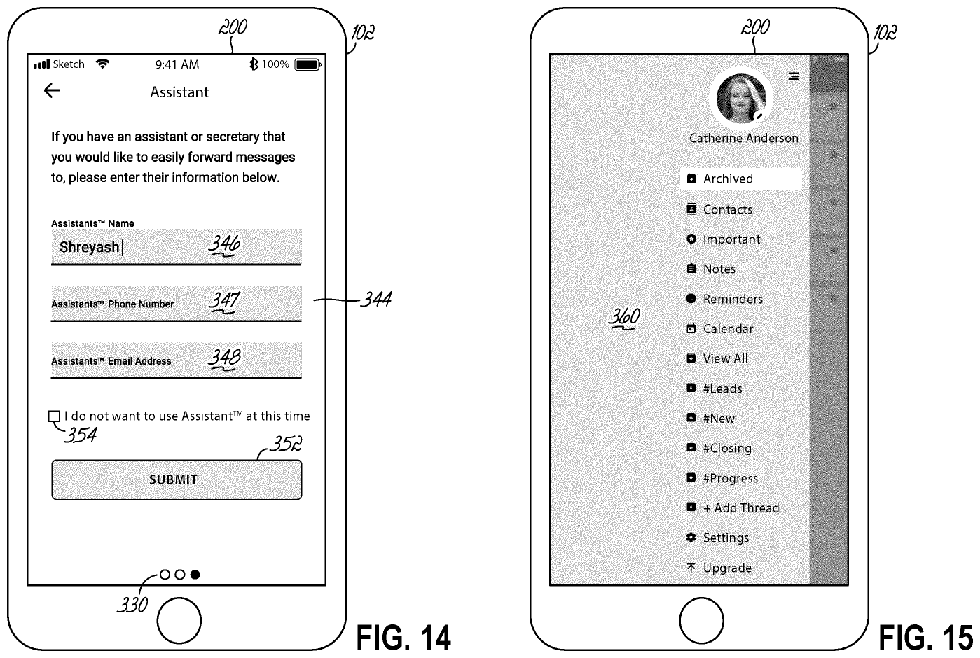

FIG. 15 depicts a screen 360 that displays a contact as well as a plurality of bucket icons, screen access icons, or other graphic elements that enable the user to view messages that have been saved to a particular bucket, contacts, notes, reminders, a calendar, add a thread, view a change settings screen, or upgrade the service level provided by the message management system 112.

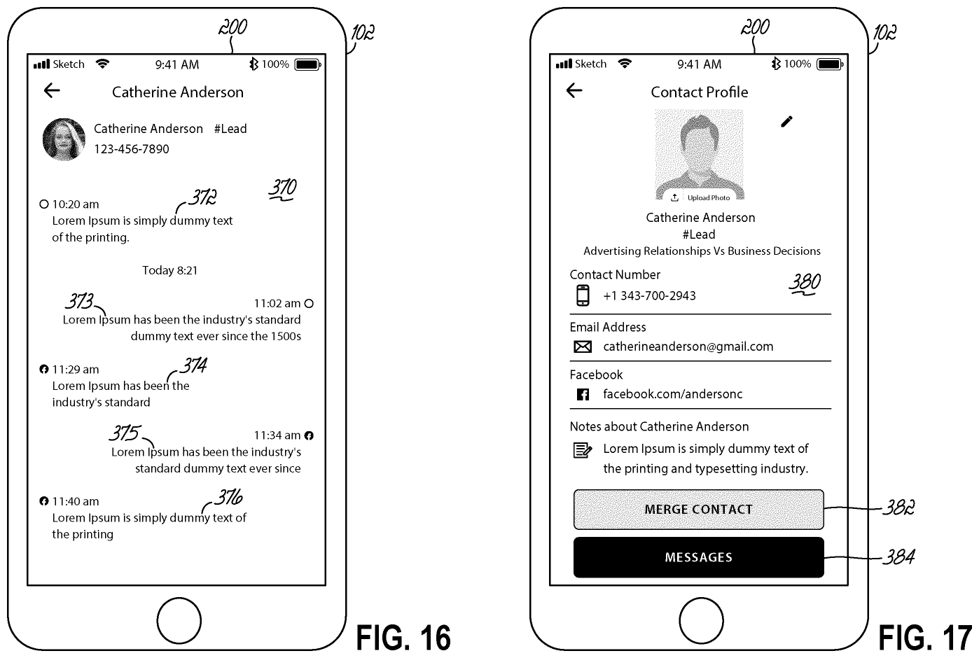

FIG. 16 depicts a screen 370 that displays messages 372-376 received from and sent to the contact depicted in FIG. 15. Each message may include a text box, a time-stamp, an icon showing the type of message, e.g., SMS, email, social media messaging application. Each message may be positioned (e.g., indented) by a predetermined amount to indicate whether the message was received from or sent to the contact.

FIG. 17 depicts an exemplary contact screen 380 that displays contact information, such as a phone number, email address, link to a social media home page, and notes about the contact. The contact screen 380 may include a button 382 for merging the contact with another contact (e.g., to consolidate a phone number, email, or a social media home page link into a single contact record), and a button 384 that displays messages received from or sent to the contact.

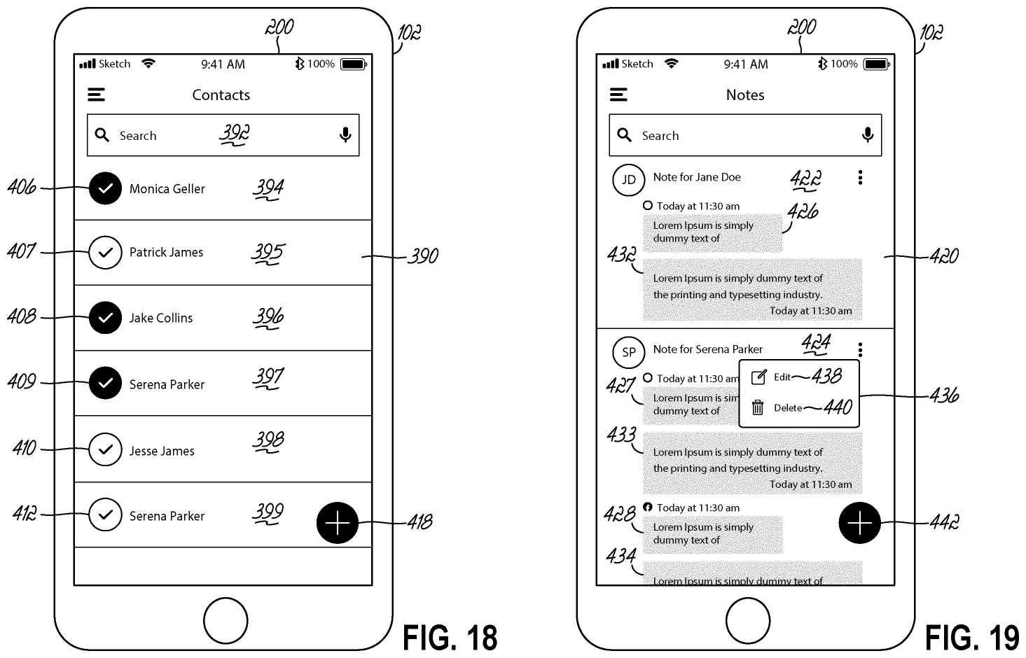

FIG. 18 depicts an exemplary contact screen 390 that may be displayed by the user interface 200 in response to the user activating the button 384 of screen 380. The contact screen 390 may include a search data entry field 392, and one or more contact windows 394-399. Each contact window 394-399 may include a check button 406-412 that allows the user to select contacts. Activating an add button 418 may cause the message management application 116 to add the selected contacts to a group that defines a thread or bucket.

FIG. 19 depicts an exemplary notes screen 420 that may be displayed by the user interface 200 in response to the user activating the notes icon of screen 360. The notes screen 420 may include one or more windows 422, 424 each corresponding to a contact and including a one or more message data fields 426-428 and one or more note data fields 432-434. In response to the user activating a message data field (e.g., by touching the field on a touchscreen), the message management system 112 may cause the user interface 200 to display a popup window 436 including icons 438, 440 that allow the user to edit or delete the note. The notes screen may also include a button 442 that enables the user to add a note to a message.

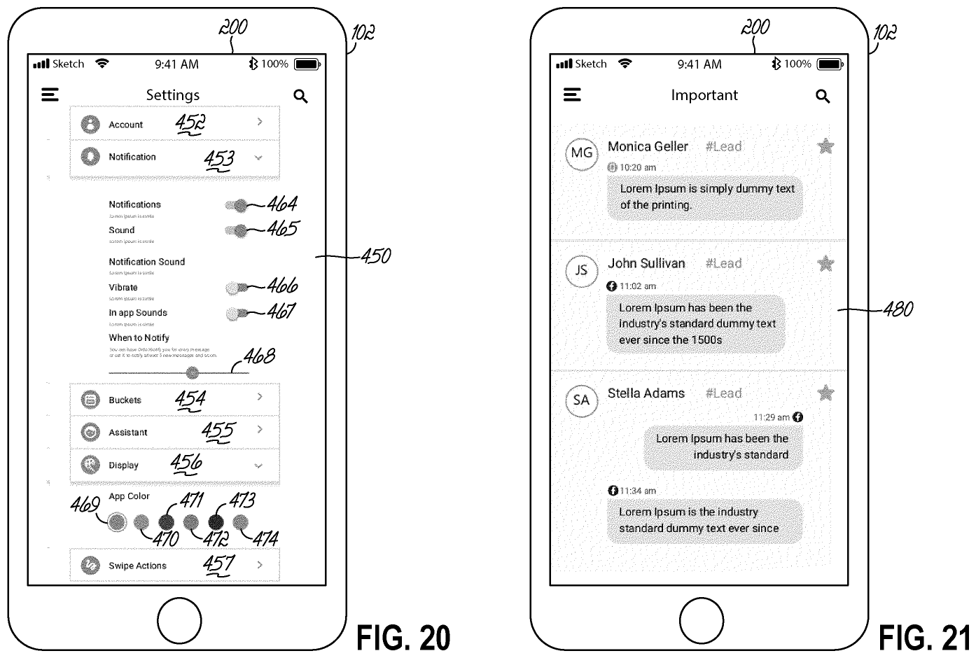

FIG. 20 depicts an exemplary settings screen 450 that may be displayed by the user interface 200 in response to the user activating the settings icon of screen 360. The settings screen may include one or more graphic elements 452-457. When a graphic element 452-457 is opened, a window or new screen may be displayed that includes one or more additional graphic elements 464-474 (e.g., buttons, check boxes, sliders, etc.) that enable the user to manipulate settings.

FIG. 21 depicts an exemplary screen 480 that may be displayed by the user interface 200 in response to the user activating the important messages icon of screen 360.

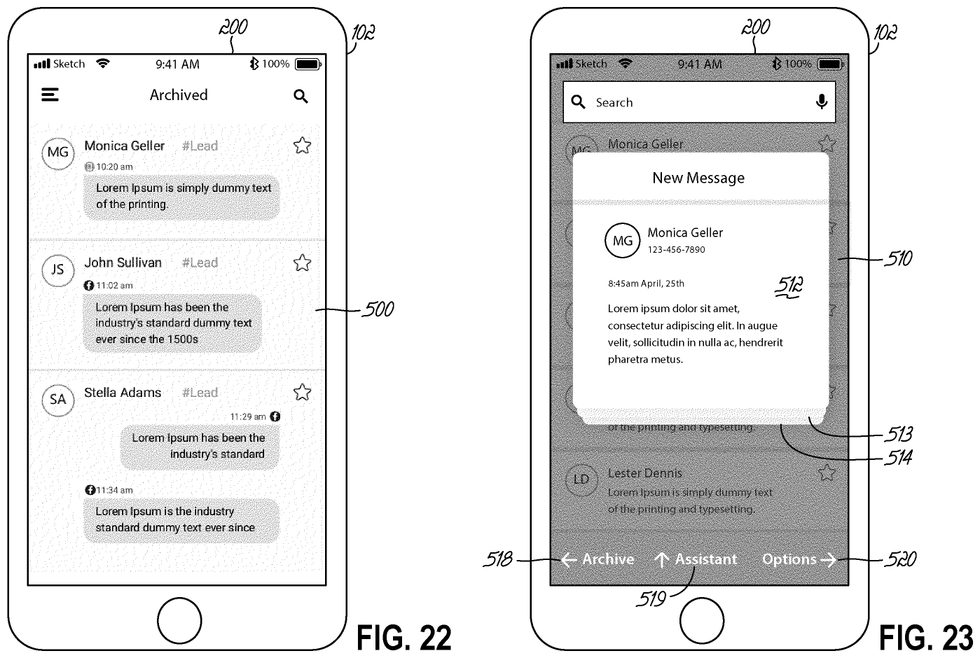

FIG. 22 depicts an exemplary screen 500 that may be displayed by the user interface 200 in response to the user activating the archived messages icon of screen 360.

FIG. 23 depicts an exemplary screen 510 that may be displayed by the user interface 200 in response to the user activating one of the contact windows (e.g., contact window 394) of screen 390 or the messages button 384 of screen 380. The screen 510 may include a plurality of messages 512-514 arranged in a stack with the selected message on top. The screen 510 may also include one or more graphic elements 518-520 that provide the user with options for sorting or routing the selected message, e.g., archive the message, forward to assistant, or open an options menu. FIG. 24 depicts screen 510 after the user has activated graphic element 518, thereby indicating message 512 should be archived. In response, the message may move off the top of the stack in a predetermined direction (e.g., to the left), and an indication that the message has been archived displayed. This indication may be provided by a graphic element that includes an undo button that may be activated to undo the archiving of the message.

The message management system 112 may provide a message review process that gives the user multiple options on what action to take with each message. For example, the user may be provided with the option of forwarding a message received through one type of communication channel (e.g., a social media messaging channel or a text messaging channel) to another type of communication channel (e.g., an email channel). This may enable the user to have messages sent to them via a social media messaging application or as a text message forwarded to the user's email account, either automatically or in response to input from the user.

By way of example, in response to the user swiping right on a message and selecting “Send to Email”, the message management system 112 may forward the text message along with the entire message thread from that contact as an email to the user's email account. The user's email account may be identified by the user when initially signing up for the service. A back-end system (e.g., the message management server 114) may then configure this message forwarding action using the user's email address. The message forwarding feature may allow users who do not have an assistant, run small businesses, freelance, etc., the ability to keep organized records of communication, and remind themselves and others of content within the message.

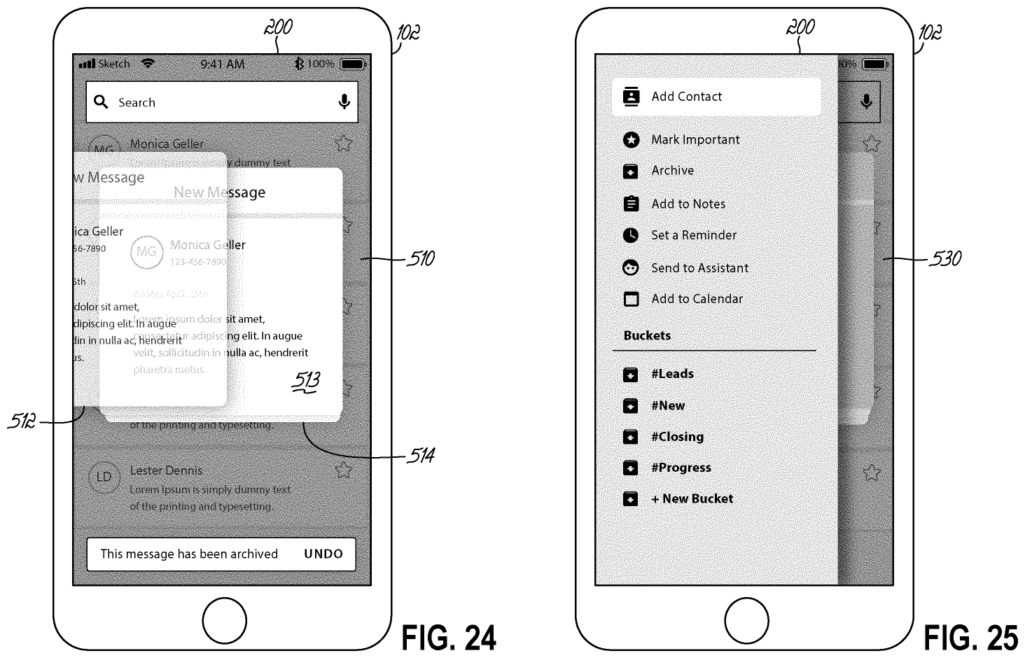

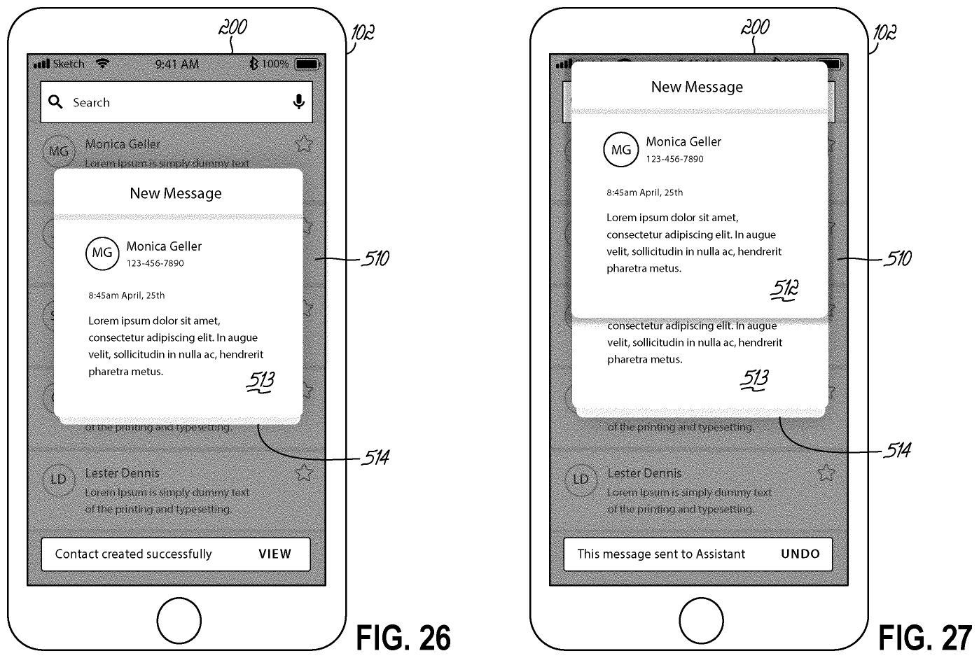

FIG. 25 depicts an exemplary screen 530 that may be displayed by the user interface 200 in response to the user activating the options graphic element 520. Screen 530 may provide the user with one or more options, such as add contact, mark message as important, archive message, add to notes, set a reminder, send to assistant, add to calendar, add to an existing bucket, or create a new bucket. As depicted in FIG. 26, in response to selecting the add contact graphic element, the user interface 200 may display screen 510 with an indication that the contact was successfully created. This indication may be provided by a graphic element that includes a view button which may be activated to display a screen showing a contact profile screen for the contact, e.g., similar to contact profile screen 380 of FIG. 17.

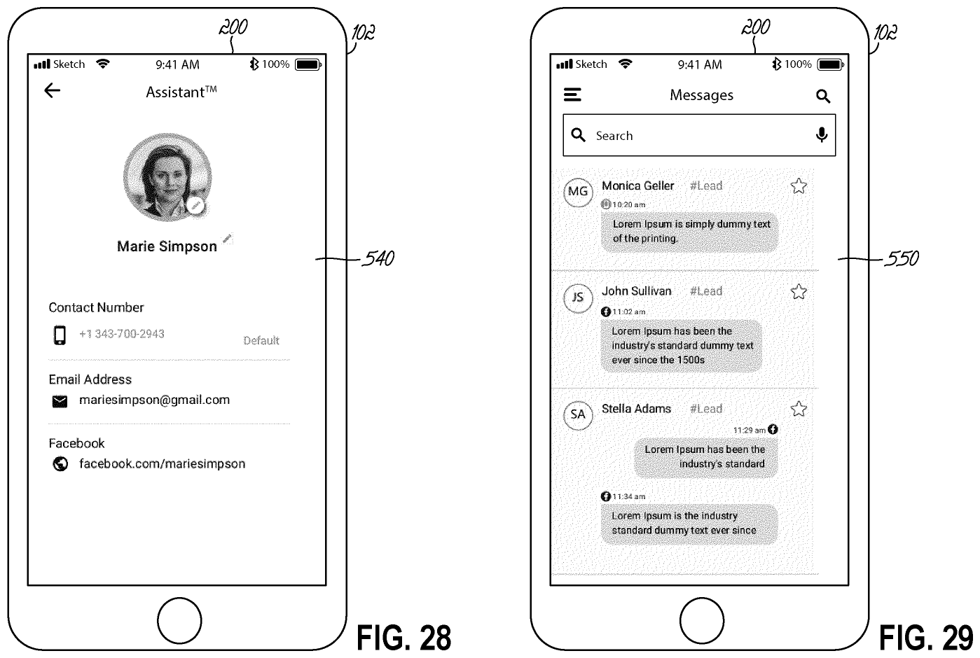

FIG. 27 depicts screen 510 after the user has activated graphic element 519, thereby indicating message 512 should be sent to the assistant. In response, the message may move off the top of the stack in a predetermined direction (e.g., upward), and an indication that the message has been sent to the assistant displayed. This indication may be provided by a graphic element that includes an undo button which may be activated to cancel the message. As depicted by FIG. 28, the user interface 200 may also display a screen 540 that provides information relating to the assistant.

FIG. 29 depicts an exemplary screen 550 that may be displayed by the user interface 200 showing messages saved to the lead bucket.

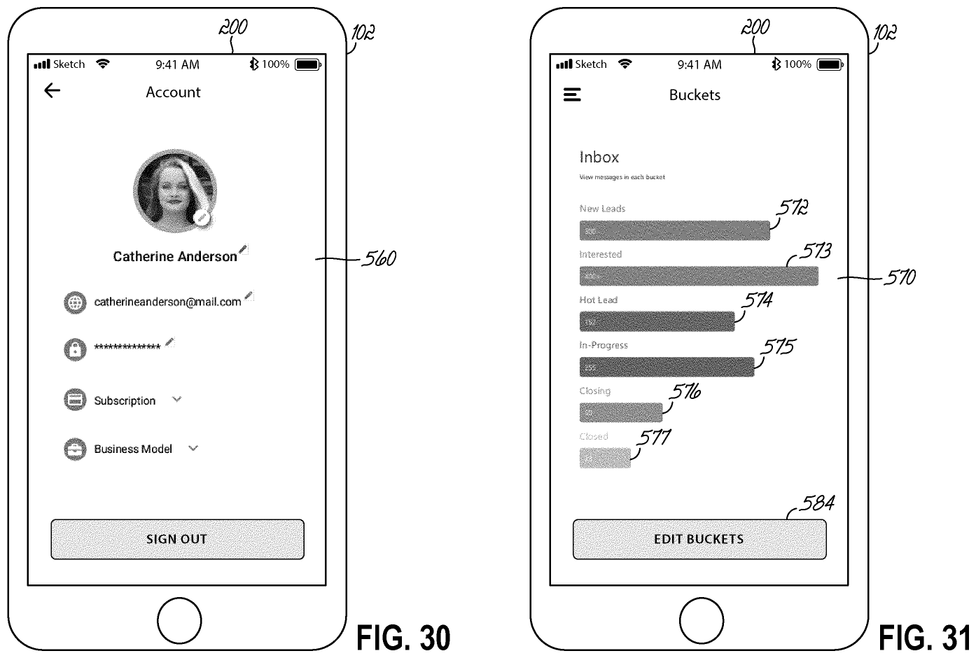

FIG. 30 depicts an exemplary screen 560 showing account information of the user that may be displayed by the user interface 200, e.g., in response to the user activating the account icon of screen 450.

FIG. 31 depicts an exemplary screen 570 showing information relating to buckets that may be displayed by the user interface 200, e.g., in response to the user activating the buckets icon of screen 450. Screen 570 may include graphic elements 572-577 (e.g., bar graphs) each providing information (e.g., a number of messages) regarding a respective bucket. Screen 570 may also include a graphic element 584 activation of which allows the user to edit the buckets.

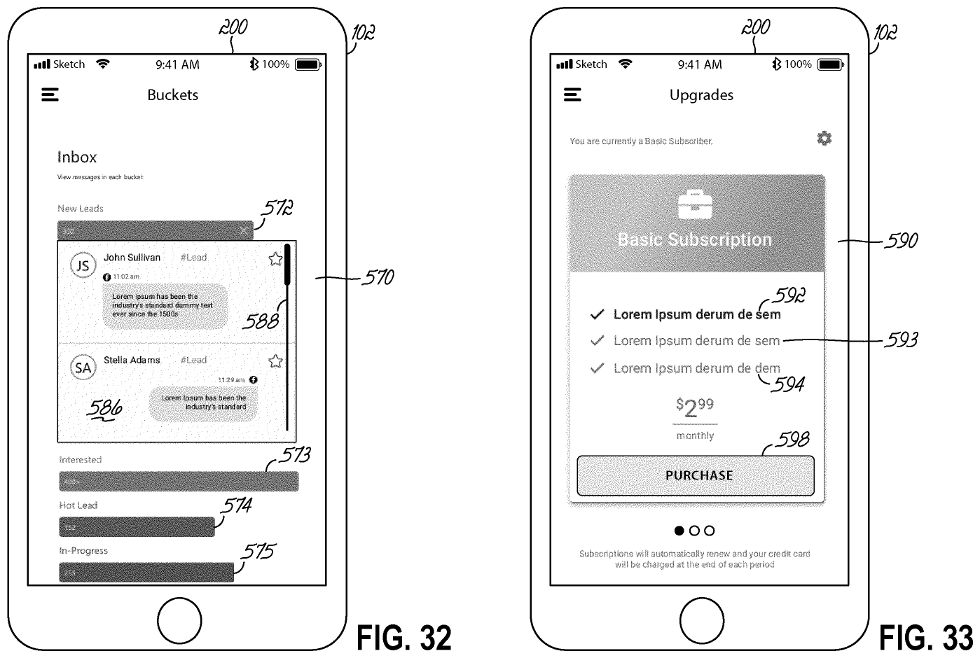

FIG. 32 depicts screen 570 as it may appear after the user has activated graphic element 572, e.g., by tapping graphic element 572. Activating graphic element 572 may cause the user interface 200 to display a drop-down window 586 that displays messages in the bucket and a graphic element 588 (e.g., a scroll bar) that enables the user to browse through the messages.

FIG. 33 depicts an exemplary upgrade screen 590 that may be displayed by the user interface 200 in response to the user activating the upgrade icon of screen 360. The upgrade screen 590 may enable the user to change the level of service they receive from the message management system 112. To this end, the screen 590 may include one or more graphic elements 592-594 that can be activated to select a desired service level, and a graphic element 598 which can be used to confirm a purchase of the selected service level.

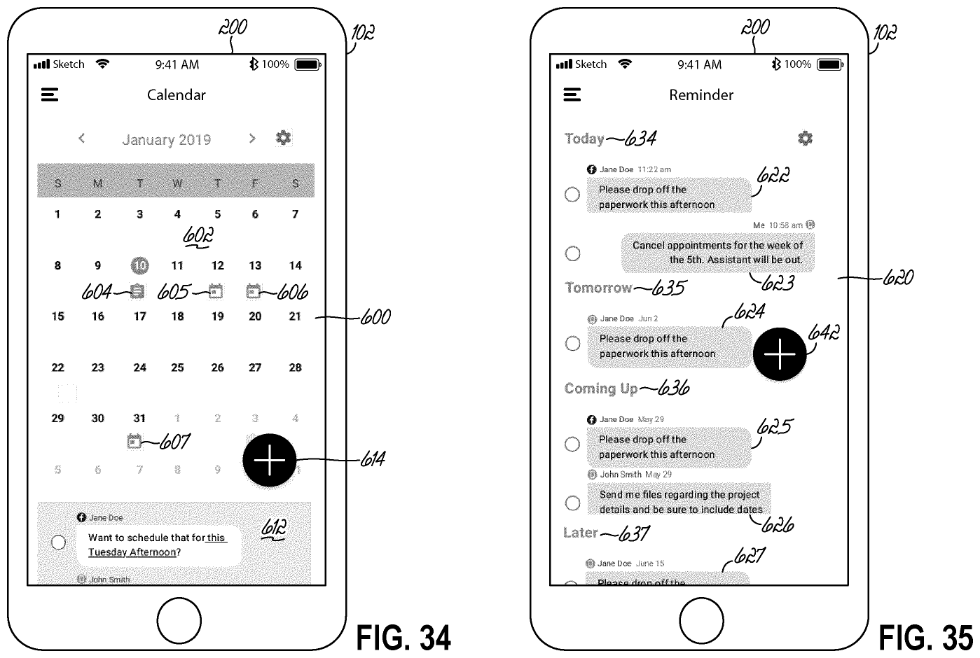

FIG. 34 depicts an exemplary calendar screen 600 that may be displayed by the user interface 200 in response to the user activating the calendar icon of screen 360. The calendar screen 600 may enable the user to view/edit existing events and create new events. The calendar screen 600 may include calendar graphic 602 (e.g., a table formatted month) including icons 604-607 representing events or messages associated with dates of the calendar graphic 602. Messages 612 associated with dates on the calendar graphic may be displayed below the calendar graphic, and may be viewed by scrolling down the screen 600. The screen 600 may also include a graphic element 614 that the user can activate to add a reminder to the calendar.

FIG. 35 depicts an exemplary reminder screen 620 that may be displayed by the user interface 200 in response to the user activating the reminders icon of screen 360. The reminder screen 620 may include one or more messages/events 622-627 corresponding to the messages/events shown on the calendar screen 600. These messages/events 622-627 may be arranged vertically in the order of their occurrence, with messages/events 622-627 occurring over different periods of time separated by one or more headers 634-637. The screen 620 may also include a graphic element 642 that the user can activate to add a reminder.

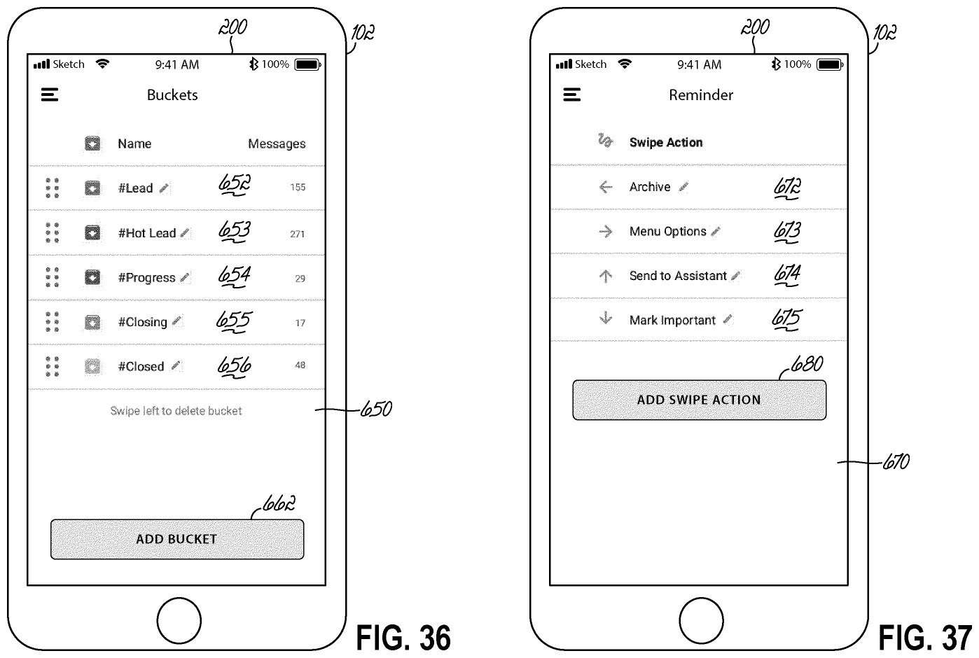

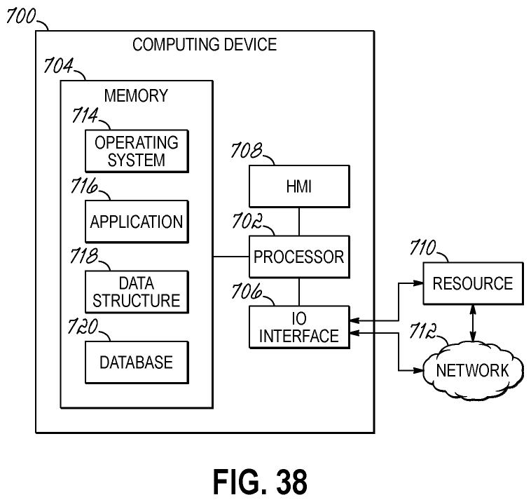

FIG. 36 depicts an exemplary bucket management screen 650 that may be displayed by the user interface 200 in response to the user activating the edit buckets graphic element 584 of screen 570. The bucket management screen 650 may include one or more data fields 652-656 each corresponding to a bucket defined in the system. The bucket management screen 650 may also include a graphic element 662 that the user can activate to add a bucket.

FIG. 37 depicts an exemplary swipe action screen 670 that may be displayed by the user interface 200 in response to the user activating the swipe action graphic element 457 of screen 450. The swipe action screen 670 may include one or more data fields 672-675 each corresponding to a swipe action defined in the system. The screen 670 may also include a graphic element 680 that the user can activate to add a swipe action.

Referring now to FIG. 37, embodiments of the invention described above, or portions thereof, may be implemented using one or more computer devices or systems, such as exemplary computer 700. The computer 700 may include a processor 702, a memory 704, an input/output (I/O) interface 706, and a Human Machine Interface (HMI) 708. The computer 700 may also be operatively coupled to one or more external resources 710 via the network 712 or I/O interface 706. External resources may include, but are not limited to, servers, databases, mass storage devices, peripheral devices, cloud-based network services, or any other resource that may be used by the computer 700.

The processor 702 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 704. Memory 704 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 702 may operate under the control of an operating system 714 that resides in memory 704. The operating system 714 may manage computer resources so that computer program code embodied as one or more computer software applications, such as an application 716 residing in memory 704, may have instructions executed by the processor 702. In an alternative embodiment, the processor 702 may execute the application 716 directly, in which case the operating system 714 may be omitted. One or more data structures 718 may also reside in memory 704, and may be used by the processor 702, operating system 714, or application 716 to store or manipulate data.

The I/O interface 706 may provide a machine interface that operatively couples the processor 702 to other devices and systems, such as the external resource 710 or the network 712. The application 716 may thereby work cooperatively with the external resource 710 or network 712 by communicating via the I/O interface 706 to provide the various features, functions, applications, processes, or modules comprising embodiments of the invention. The application 716 may also have program code that is executed by one or more external resources 710, or otherwise rely on functions or signals provided by other system or network components external to the computer 700. Indeed, given the nearly endless hardware and software configurations possible, persons having ordinary skill in the art will understand that embodiments of the invention may include applications that are located externally to the computer 700, distributed among multiple computers or other external resources 710, or provided by computing resources (hardware and software) that are provided as a service over the network 712, such as a cloud computing service.

The HMI 708 may be operatively coupled to the processor 702 of computer 700 to allow a user to interact directly with the computer 700. The HMI 708 may include video or alphanumeric displays, a touch screen, a speaker, and any other suitable audio and visual indicators capable of providing data to the user. The HMI 708 may also include input devices and controls such as an alphanumeric keyboard, a pointing device, keypads, pushbuttons, control knobs, microphones, etc., capable of accepting commands or input from the user and transmitting the entered input to the processor 702.

A database 720 may reside in memory 704, and may be used to collect and organize data used by the various systems and modules described herein. The database 720 may include data and supporting data structures that store and organize the data. In particular, the database 720 may be arranged with any database organization or structure including, but not limited to, a relational database, a hierarchical database, a network database, or combinations thereof. A database management system in the form of a computer software application executing as instructions on the processor 702 may be used to access the information or data stored in records of the database 720 in response to a query, which may be dynamically determined and executed by the operating system 714, other applications 716, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1-61. (canceled)

62. A system comprising:
one or more processors; and
a memory coupled to the one or more processors and including program code that, when executed by the one or more processors, causes the system to:
receive a first message from a first communication channel of a plurality of communication channels;
in response to receiving the first message, prompt a user to identify a bucket to which the first message should be added;
in response to receiving input identifying the bucket, store the first message in a database; and
index the first message to the identified bucket in the database.

63. The system of claim 62, wherein the first message is associated with a thread including a plurality of messages, and the program code further causes the system to:
define the thread based on participants in the thread, the participants including a sender of the first message and a recipient of the first message.

64. The system of claim 63 wherein the program code further causes the system to index the first message to the thread in the database.

65. The system of claim 62 wherein the program code comprises a client application running on a user system and a server application running on a server system, the first communication channel has a first format, and the program code further causes the system to:
receive, by the server application, a second message from a second communication channel having a second format;
reformat, by the server application, the second message into the first format; and
transmit the reformatted second message from the server application to the client application.

66. The system of claim 65 wherein the first communication channel is a text messaging communication channel, and the second communication channel is a social media system communication channel.

67. The system of claim 62, wherein the program code further causes the system to:
receive, by a filter application from a message application, a query requesting instructions for processing the first message received from the first communication channel;
in response to receiving the query, transmit, by the filter application, a reply to the message application instructing the message application to forward the first message to a first network address; and
receive, by a management application, the first message from a second communication channel different than the first communication channel.

68. The system of claim 67, wherein the program code further causes the system to:
receive the first message at a server associated with the first network address;
determine, by the server, a second network address associated with the management application; and
transmit the first message from the server to the second network address.

69. The system of claim 68 wherein the server determines the second network address based on data contained in the first message that identifies a mobile device.

70. A method comprising:
receiving a first message from a first communication channel of a plurality of communication channels;
in response to receiving the first message, prompting a user to identify a bucket to which the first message should be added;
in response to receiving input identifying the bucket, storing the first message in a database; and
indexing the first message to the identified bucket in the database.

72. The method of claim 70, wherein the first message is associated with a thread including a plurality of messages, and further comprising:
defining the thread based on participants in the thread, the participants including a sender of the first message and a recipient of the first message.

73. The method of claim 71 further comprising indexing the first message to the thread in the database.

73. The method of claim 72 wherein the plurality of communication channels includes a social media messaging channel, a text messaging channel, and an email channel.

74. The method of claim 70, wherein the first communication channel has a first format, and further comprising:
receiving, by a server application, a second message from a second communication channel having a second format;
reformatting, by the server application, the second message into the first format; and
transmitting the reformatted second message from the server application to a client application.

75. The method of claim 74 wherein the first communication channel is a text messaging communication channel, and the second communication channel is a social media system communication channel.

76. The method of claim 70, further comprising:
receiving, by a filter application from a message application, a query requesting instructions for processing the first message received from the first communication channel;
in response to receiving the query, transmitting, by the filter application, a reply to the message application instructing the message application to forward the first message to a first network address; and
receiving, by a management application, the first message from a second communication channel different than the first communication channel.

77. The method of claim 76, further comprising:
receiving the first message at a server associated with the first network address;
determining, by the server, a second network address associated with the management application; and
transmitting the first message from the server to the second network address.

78. The method of claim 77 wherein the server determines the second network address based on data contained in the first message that identifies a mobile device.

79. The method of claim 76, wherein the first network address is a fixed network address.

80. The method of claim 76, wherein the second communication channel is not monitored by the filter application.

81. A computer program product comprising:
a non-transitory computer-readable storage medium; and
program code stored on the non-transitory computer-readable storage medium that, when executed by one or more processors, causes the one or more processors to:
receive a first message from a first communication channel of a plurality of communication channels;
in response to receiving the first message, prompt a user to identify a bucket to which the message should be added;
in response to receiving input identifying the bucket, store the first message in a database; and
index the first message to the identified bucket in the database.
